(19) United States
(12) Patent Application Publication
(10) Pub. No.: US 2021/0064867 A1
(43) Pub. Date: Mar. 4, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Masashi BAN, Kanagawa (JP)

(73) Assignee: FUJI XEROX CO., LTD., Tokyo (JP)

(21) Appl. No.: 16/790,766

(22) Filed: Feb. 14, 2020

(30) Foreign Application Priority Data
Aug. 28, 2019 (JP) 2019-155885

(51) Int. Cl. G06K 9/00; G06K 9/62

(52) U.S. Cl. CPC G06K 9/00469; G06K 2209/01; G06K 9/6262; G06K 9/00402

(57) ABSTRACT

An information processing apparatus includes a processor. The processor is configured to acquire an evaluation form image in which an item and correct answer data indicating a correct answer of a recognition result for the item are associated with each other in advance; and output, when the acquired evaluation form image is processed in at least one step of form processing, an evaluation result of the at least one step of the form processing.

### CROSS-REFERENCE TO RELATED APPLICATIONS

This application is based on and claims priority under 35 USC 119 from Japanese Patent Application No. 2019-155885 filed Aug. 28, 2019.

### BACKGROUND

### (i) Technical Field

The present disclosure relates to an information processing apparatus and a non-transitory computer readable medium.

### (ii) Related Art

For example, Japanese Unexamined Patent Application Publication No. 8-44828 describes a character recognition evaluation processing method for evaluating the rate of character recognition performed by a character recognition apparatus. In the recognition evaluation processing method, a character storage apparatus stores character images of characters together with attribute information of the characters. The recognition evaluation processing method includes generating a form image using character images that are read from the character storage apparatus and that are displayed and selected, and inputting the form image to the character recognition apparatus.

Japanese Unexamined Patent Application Publication No. 11-341210 describes an evaluation processing method for evaluating the rate and time of character recognition performed by a FAX-OCR (character recognition) apparatus. The evaluation processing method includes storing character strings to be written in each form as one record in a filled-in character storage file, and reading a record from the filled-in character storage file. The evaluation processing method further includes dividing the read record into items, and embedding character strings obtained as a result of dividing the record in items whose font names, character styles, and character sizes are designated as character attribute information of items to be embedded in a fixed format to automatically generate forms one by one. The evaluation processing method further includes automatically transmitting the automatically generated forms from a facsimile (FAX) transmission apparatus to the FAX-OCR apparatus, matching each record of a recognition result file that stores results obtained by the FAX-OCR apparatus through character recognition against a record of a filled-in character storage file that stores expected character data corresponding to the record, determining whether text has been correctly read, unreadable, or erroneously recognized, and counting results. The evaluation processing method further includes storing at least a recognition rate and a recognition time in a verification result file, reading the recognition rate and the recognition time from the verification result file, and displaying the recognition rate and the recognition time on a display or printing the recognition rate and the recognition time on a sheet of paper.

### SUMMARY

A form processing system is available. In the form processing system, an area to be recognized, a dictionary to be used, and so on are defined for a form image to be recognized, the form image is recognized, a recognition result is validated, and a validation result is output. After the operation of the form processing system is actually started, the problem of accuracy, man-hour, cost, and so on may be found in steps of form processing (such as a reading step, a recognition step, and a validation step). However, the validity of accuracy, man-hour, cost, and so on of each step is difficult to evaluate in advance before the start of operation of the form processing system.

Aspects of non-limiting embodiments of the present disclosure relate to an information processing apparatus and a non-transitory computer readable medium for evaluating the validity of at least one step of form processing in advance before the start of operation of a form processing system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor. The processor is configured to acquire an evaluation form image in which an item and correct answer data indicating a correct answer of a recognition result for the item are associated with each other in advance; and output, when the acquired evaluation form image is processed in at least one step of form processing, an evaluation result of the at least one step of the form processing.

### BRIEF DESCRIPTION OF THE DRAWINGS

An exemplary embodiment of the present disclosure will be described in detail based on the following figures, wherein:

FIG. 1 illustrates an example configuration of a form processing system according to the exemplary embodiment;

FIG. 2 is a block diagram illustrating an electrical configuration of a server apparatus according to the exemplary embodiment;

FIG. 3 is a block diagram illustrating an example functional configuration of the server apparatus according to the exemplary embodiment;

FIG. 4 illustrates a step evaluation process for all steps according to the exemplary embodiment;

FIG. 5 illustrates a step evaluation process for some steps according to the exemplary embodiment;

FIG. 6 illustrates another step evaluation process for some steps according to the exemplary embodiment;

FIG. 7 illustrates still another step evaluation process for some steps according to the exemplary embodiment;

FIG. 8 is a flowchart illustrating an example process flow of an information processing program according to the exemplary embodiment;

FIG. 9 illustrates a correct answer data generation process according to the exemplary embodiment;

FIG. 10 is a flowchart illustrating an example flow of the correct answer data generation process according to the exemplary embodiment;

FIG. 11 illustrates an evaluation form image generation process according to the exemplary embodiment;

FIG. 12 is a flowchart illustrating an example flow of the evaluation form image generation process according to the exemplary embodiment;

FIG. 13 illustrates an example of correct answer data, a blank form, and evaluation form sheets according to the exemplary embodiment;

FIG. 14 is a front view of an example of a data entry result evaluation screen according to the exemplary embodiment;

FIG. 15 is a front view of another example of the data entry result evaluation screen according to the exemplary embodiment;

FIG. 16 is a front view of an example of a data entry progress screen according to the exemplary embodiment; and

FIG. 17 is a front view of an example of a data entry result report screen according to the exemplary embodiment.

### DETAILED DESCRIPTION

The following describes an exemplary embodiment of the present disclosure in detail with reference to the drawings.

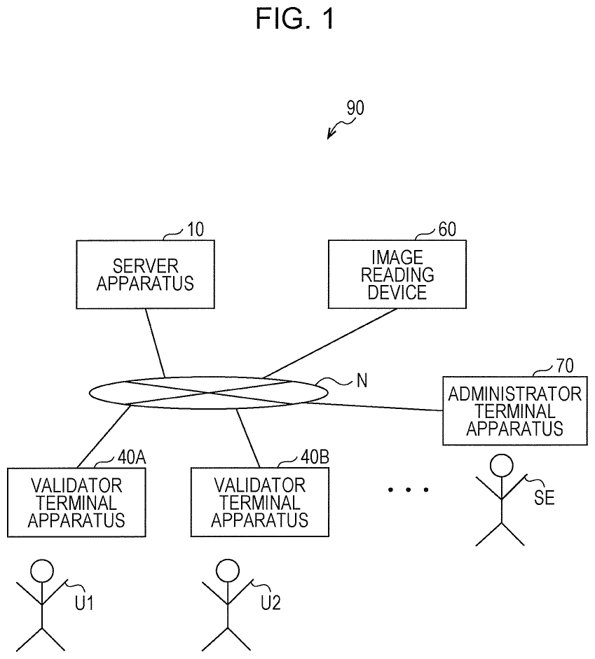

FIG. 1 illustrates an example configuration of a form processing system 90 according to this exemplary embodiment.

As illustrated in FIG. 1, the form processing system 90 according to this exemplary embodiment includes a server apparatus 10, validator terminal apparatuses 40A, 40B, etc., an image reading device 60, and an administrator terminal apparatus 70. The server apparatus 10 is an example of an information processing apparatus.

The server apparatus 10 is connected so as to be capable of communicating with the validator terminal apparatuses 40A, 40B, etc., the image reading device 60, and the administrator terminal apparatus 70 via a network N. The server apparatus 10 is implemented by, for example, a general-purpose computer such as a server computer or a personal computer (PC). Examples of the network N include the Internet, a local area network (LAN), and a wide area network (WAN).

The image reading device 60 has a function of optically reading a paper form to obtain an image and transmitting the obtained image (hereinafter referred to as a “form image”) to the server apparatus 10. The term “form”, as used herein, refers to any document form containing items such as name and address. The form is filled in for each of the items with handwritten characters, printed characters, and the like. Specifically, as described below, the server apparatus 10 performs optical character recognition (OCR) processing on the form image received from the image reading device 60 to acquire a recognition result of an image corresponding to each of the items. The recognition result includes, for example, a character string indicating a sequence of characters containing one or more letters. In the form, areas to be filled in, which correspond to the items, are bounded by frames or the like, and the areas to be filled in are defined as areas to be subjected to recognition. OCR processing is performed on the defined areas to acquire character strings for the respective images corresponding to the items.

The validator terminal apparatus 40A is a terminal apparatus operated by a validator (user) U1 who performs a validation operation, and the validator terminal apparatus 40B is a terminal apparatus operated by a validator U2 who performs a validation operation. The validator terminal apparatuses 40A, 40B, etc. are also referred to collectively as “validator terminal apparatuses 40” or individually as a “validator terminal apparatus 40” unless the validator terminal apparatuses 40A, 40B, etc. need be distinguished from each other. Also, the validators U1, U2, etc. are also referred to collectively as “validators U” or individually as a “validator U” unless the validators U1, U2, etc. need be distinguished from each other. Examples of the validator terminal apparatus 40 include a general-purpose computer such as a PC, and a portable terminal apparatus such as a smartphone and a tablet terminal. The validator terminal apparatus 40 has installed therein a validation application program (hereinafter referred to also as a “validation application”) for allowing the validator U to perform a validation operation. The validator terminal apparatus 40 generates and displays a validation operation user interface (UI) screen. The term “validation” or “validation operation”, as used herein, refers to an operation of validating (and correcting, if any) a recognition result of characters or the like in the form image.

The administrator terminal apparatus 70 is a terminal apparatus operated by a system administrator SE. The system administrator SE configures form definition data through a form definition screen (not illustrated). The form definition data is data used to recognize a form image, and, for example, a sheet size and information on a recognition frame (such as the item name, size, and coordinates of the recognition frame, the type of characters in the recognition frame, and a recognition dictionary) are defined. Examples of the administrator terminal apparatus 70 include a general-purpose computer such as a PC, and a portable terminal apparatus such as a smartphone and a tablet terminal.

The form image includes sub-images corresponding to items (hereinafter referred to as “item images”), and each of the item images is recognized to obtain a recognition result. If the recognition result has a confidence level less than a threshold, the server apparatus 10 makes a person manually validate the recognition result. If the recognition result has a confidence level greater than or equal to the threshold, the server apparatus 10 outputs the recognition result as a final recognition result without performing any manual validation operation. The confidence level is a measure of how confident the recognition result is. The higher the value of the confidence level, the higher the probability of matching between the item image and the recognition result.

To perform the validation operation described above, the server apparatus 10 performs control to display each of the item images and a character string obtained by OCR processing on the UI screen of the validator terminal apparatus 40 in association with each other. The validator U views each of the item images and validates whether the character string corresponding to the item image is correct. As a result of the validation, if the character string is correct, the validator U performs no operation, and if the character string is not correct, the validator U inputs a correct character string on the UI screen. The validator terminal apparatus 40 transmits the character string whose input is accepted through the UI screen to the server apparatus 10 as a validation result. The server apparatus 10 outputs a final recognition result based on the validation result from the validator terminal apparatus 40, and performs control to display the final recognition result on the UI screen of the validator terminal apparatus 40.

In the validation operation described above, a type of entry indicating the method by which the validation operation is performed is set. Any one of “double entry” and “single entry” is set as an example type of entry. “Double entry” is a method by which a plurality of validators perform a validation operation, and “single entry” is a method by which a single validator performs a validation operation.

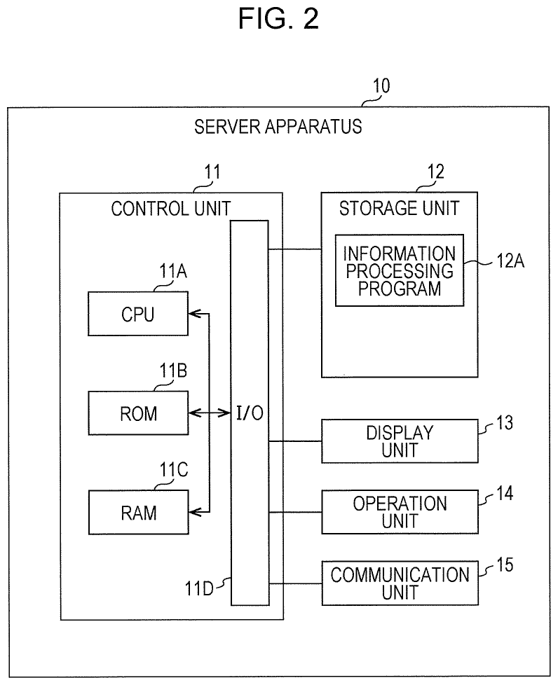

FIG. 2 is a block diagram illustrating an example electrical configuration of the server apparatus 10 according to this exemplary embodiment.

As illustrated in FIG. 2, the server apparatus 10 according to this exemplary embodiment includes a control unit 11, a storage unit 12, a display unit 13, an operation unit 14, and a communication unit 15.

The control unit 11 includes a central processing unit (CPU) 11A, a read only memory (ROM) 11B, a random access memory (RAM) 11C, and an input/output interface (I/O) 11D. The CPU 11A, the ROM 11B, the RAM 11C, and the I/O 11D are interconnected via a bus.

The I/O 11D is connected to functional units including the storage unit 12, the display unit 13, the operation unit 14, and the communication unit 15. Each of the functional units is capable of communicating with the CPU 11A via the I/O 11D.

The control unit 11 may be configured as a sub-control unit that controls part of the operation of the server apparatus 10, or may be configured as part of a main control unit that controls the overall operation of the server apparatus 10. Some or all of the blocks of the control unit 11 are implemented using, for example, an integrated circuit (IC) such as a large scale integrated (LSI) circuit or an IC chip set. Each of the blocks may be implemented as a single separate circuit, or some or all of the blocks may be integrated on a circuit. Alternatively, the blocks may be formed into a single unit, or some of the blocks may be disposed in a separate portion. In each of the blocks, a portion thereof may be disposed in a separate portion. The control unit 11 may be integrated by using a dedicated circuit or a general-purpose processor instead of by using an LSI circuit.

Examples of the storage unit 12 include a hard disk drive (HDD), a solid state drive (SSD), and a flash memory. The storage unit 12 stores an information processing program 12A according to this exemplary embodiment. The information processing program 12A may be stored in the ROM 11B.

The information processing program 12A may be installed in the server apparatus 10 in advance, for example. The information processing program 12A may be implemented as follows. The information processing program 12A may be stored in a non-volatile non-transitory storage medium or distributed via the network N and installed into the server apparatus 10, as necessary. Possible examples of the non-volatile non-transitory storage medium include a compact disc read only memory (CD-ROM), a magneto-optical disk, an HDD, a digital versatile disc read only memory (DVD-ROM), a flash memory, and a memory card.

Examples of the display unit 13 include a liquid crystal display (LCD) and an organic electroluminescent (EL) display. The display unit 13 may have a touch panel integrated therein. The operation unit 14 is provided with an operation input device such as a keyboard and a mouse. The display unit 13 and the operation unit 14 accept various instructions from the user of the server apparatus 10. The display unit 13 displays various types of information, examples of which include results of a process executed in accordance with an instruction accepted from the user, and a notification about the process.

The communication unit 15 is connected to the network N, such as the Internet, a LAN, or a WAN, and is allowed to communicate with each of the image reading device 60, the validator terminal apparatus 40, and the administrator terminal apparatus 70 via the network N.

Before starting the operation of the form processing system 90, the operator needs to evaluate in advance the validity of accuracy, man-hour, cost, and so on of each step of form processing, such as a reading step, a recognition step, and a validation step.

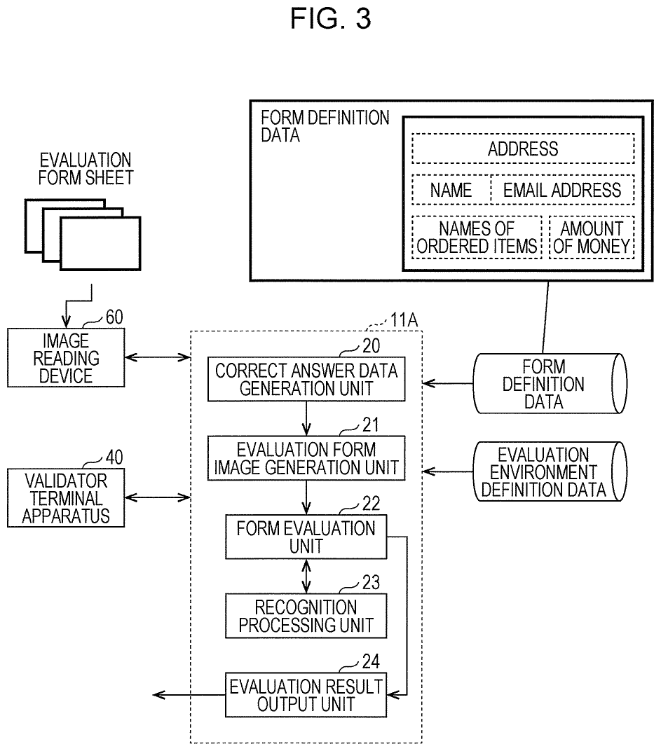

The CPU 11A of the server apparatus 10 according to this exemplary embodiment loads the information processing program 12A stored in the storage unit 12 into the RAM 11C and executes the information processing program 12A, thereby functioning as the components illustrated in FIG. 3. The CPU 11A is an example of a processor.

FIG. 3 is a block diagram illustrating an example functional configuration of the server apparatus 10 according to this exemplary embodiment.

As illustrated in FIG. 3, the CPU 11A of the server apparatus 10 according to this exemplary embodiment functions as a correct answer data generation unit 20, an evaluation form image generation unit 21, a form evaluation unit 22, a recognition processing unit 23, and an evaluation result output unit 24.

The storage unit 12 according to this exemplary embodiment stores, for example, the form definition data described above and evaluation environment definition data. The evaluation environment definition data is data that defines in advance the operational environment related to the form processing. The operational environment includes at least one of a geographical location of a region associated with a form, a name of a company associated with the form, the age group of a person who fills in the form, and the gender of the person who fills in the form.

The correct answer data generation unit 20 generates correct answer data. The correct answer data is character data indicating a pseudo-recognition result generated in association with each item in the form image, and examples of the correct answer data include character data indicating a “name” (for example, “Taro Yamada”) when the item is “name”. The correct answer data may be data generated based on the evaluation environment definition data. In this case, for example, correct answer data corresponding to at least one of the geographical location of a region associated with a form, the name of a company associated with the form, the age group of a person who fills in the form, and the gender of the person who fills in the form is obtained. That is, correct answer data having conditions close to those of the actual operational environment is obtained. Therefore, evaluation accuracy improves. A specific process for generating the correct answer data will be described below.

The evaluation form image generation unit 21 generates an evaluation form image. The evaluation form image is an image obtained by arranging characters in a handwriting font, which is obtained by converting correct answer data, in the field of each corresponding item in a blank form. The handwriting font is font data of handwritten characters and is obtained by converting the correct answer data. The handwriting font may be a font converted from the correct answer data in accordance with the evaluation environment definition data. In this case, for example, a handwriting font corresponding to at least one of the age group of a person who fills in the form and the gender of the person who fills in the form is obtained. That is, a handwriting font having conditions close to those of the actual operational environment is obtained. Therefore, evaluation accuracy improves. A specific process for generating the evaluation form image will be described below.

The correct answer data generation unit 20 and the evaluation form image generation unit 21 may not be disposed in the server apparatus 10. Correct answer data and an evaluation form image may be generated by another server apparatus external to the form processing system 90.

The form evaluation unit 22 acquires an evaluation form image in which each item and correct answer data of a recognition result corresponding to the item are associated with each other in advance. Specifically, the form evaluation unit 22 acquires the evaluation form image generated by the evaluation form image generation unit 21. When the acquired evaluation form image is processed in at least one step of the form processing, the form evaluation unit 22 derives a value indicating the throughput for the step.

The recognition processing unit 23 receives the evaluation form image and executes OCR processing on each item in the evaluation form image in accordance with the settings in the form definition data. The recognition processing unit 23 outputs, for each of the items in the form, an item image, a recognition result, and a confidence level in association with one another.

The evaluation result output unit 24 outputs an evaluation result for the step of the form processing, including the value indicating the throughput derived for the step by the form evaluation unit 22. When the form processing includes a plurality of steps, the evaluation result output unit 24 outputs evaluation results, each of which is a result of evaluating one of the plurality of steps using a different evaluation item. That is, since the item to be evaluated differs from step to step, an evaluation result of each step using an evaluation item suitable for the step is output.

Specifically, the plurality of steps include a validation step. The validation step is a step of obtaining a validation result that is a result of a validation operation performed on a recognition result of an evaluation form image. As described above, the validation operation is performed by the validator terminal apparatus 40. In this case, the evaluation result output unit 24 outputs, for the validation step, an evaluation result including at least one of a correct recognition rate (%) of validation results for each validator and a processing time (in minute). The correct recognition rate of validation results for each validator and the processing time are derived by the form evaluation unit 22. In the case of the validation step, the correct recognition rate is expressed as the ratio of correct validation results to all validated results. The processing time is expressed as the time obtained by subtracting the processing start time from the processing end time.

The evaluation result of the validation step may include at least one of the processing time of the validation step, the correct recognition rate of validation results in the validation step, and the correct recognition rate of validation results for each of the items in the form.

The plurality of steps further include a recognition step. The recognition step is a step of obtaining a recognition result that is a result of recognizing an evaluation form image. The recognition of an evaluation form image is performed by the recognition processing unit 23. In this case, the evaluation result output unit 24 outputs, for the recognition step, an evaluation result including at least one of a correct recognition rate (%) of recognition results for each recognition dictionary and a processing time (in minute). The correct recognition rate of recognition results for each recognition dictionary and the processing time are derived by the form evaluation unit 22. In the case of the recognition step, the correct recognition rate is expressed as the ratio of correct recognition results to all recognized results. The processing time is expressed as the time obtained by subtracting the processing start time from the processing end time.

The evaluation result of the recognition step may include at least one of the processing time of the recognition step, the correct recognition rate of recognition results in the recognition step, and the correct recognition rate of recognition results for each of the items in the form.

The plurality of steps further include a reading step. The reading step is a step of obtaining a reading result that is a result of reading an evaluation form sheet representing a printout of an evaluation form image. The evaluation form sheet is printed by a printer (not illustrated) connected to the server apparatus 10. The evaluation form sheet is read by the image reading device 60. In this case, the evaluation result output unit 24 outputs an evaluation result including the processing time (in minute) of the reading step. The processing time of the reading step is derived by the form evaluation unit 22. The processing time is expressed as the time obtained by subtracting the processing start time from the processing end time.

That is, before the start of operation of the form processing system 90, the server apparatus 10 outputs evaluation results for the respective steps of the form processing, namely, the reading step, the recognition step, and the validation step, including values indicating the respective throughputs, by using an evaluation form image or an evaluation form sheet. The evaluation results are used to determine the validity of accuracy, man-hour, cost, and so on of the respective steps of the form processing.

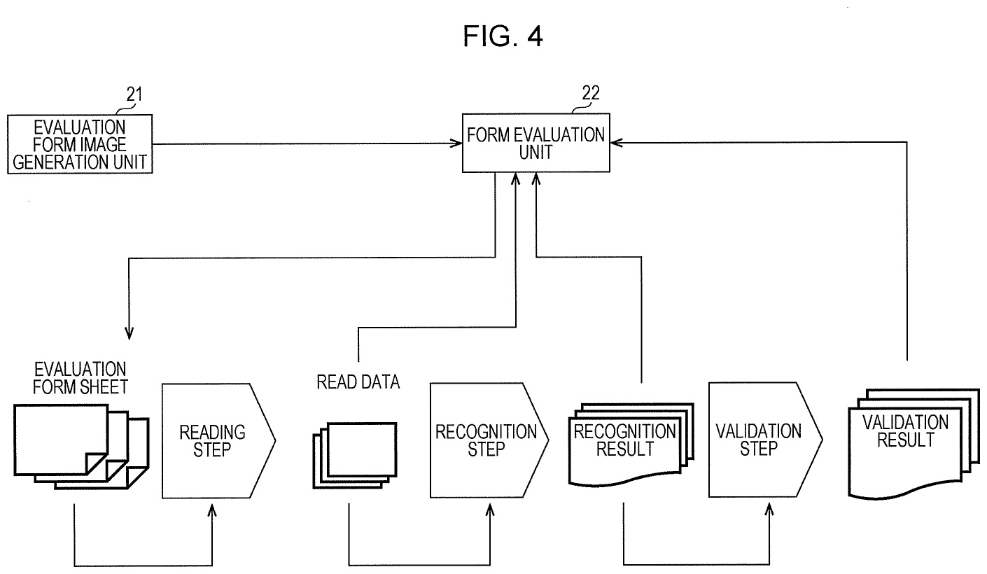

Next, a process for evaluating each of the steps of the form processing (hereinafter referred to as a “step evaluation process”) using an evaluation form image will be described in detail with reference to FIGS. 4 to 7.

FIG. 4 illustrates a step evaluation process for all steps according to this exemplary embodiment.

As illustrated in FIG. 4, the form evaluation unit 22 acquires an evaluation form image generated by the evaluation form image generation unit 21 and performs control to transmit the acquired evaluation form image to the printer. An evaluation form sheet, which is a printout of the evaluation form image, is printed by the printer and is provided to the reading step. In the reading step, the evaluation form sheet is read using the image reading device 60 to obtain read data, and the read data is then output. At this time, the form evaluation unit 22 acquires processing information of the reading step. The processing information of the reading step includes the number of processed pages, the processing start time, and the processing end time, for example. The form evaluation unit 22 derives the throughput for the reading step, examples of which include the processing time (in minute) and the processing speed (in page/minute), on the basis of the acquired processing information of the reading step.

Then, the read data output in the reading step is provided to the recognition step. In the recognition step, the read data is recognized using the recognition processing unit 23 in accordance with the form definition data to obtain a recognition result, and the recognition result is then output. At this time, the form evaluation unit 22 acquires processing information of the recognition step. The processing information of the recognition step includes the number of processed pages, the processing start time, the processing end time, the recognition dictionary, and the recognition result, for example. The number of processed pages represents the total number of recognized results. The form evaluation unit 22 derives, for each recognition dictionary, the throughput for the recognition step, examples of which include the correct recognition rate (%), the processing time (in minute), and the processing speed (in page/minute), on the basis of the acquired processing information of the recognition step. The form evaluation unit 22 determines, for each piece of read data, whether the recognition result is correct.

Then, the recognition result output in the recognition step is provided to the validation step together with the read data. In the validation step, the validation operation of the recognition result is performed on a data pair including read data and a recognition result using the validator terminal apparatus 40 to obtain a validation result, and the validation result is then output. In the validation operation, as described above, if a character string in a recognition result for the read data is incorrect, the validator corrects the incorrect character string to the correct character string. At this time, the form evaluation unit 22 acquires processing information of the validation step. The processing information of the validation step includes the number of processed pages, the processing start time, the processing end time, the name of the validator, and the validation result, for example. The number of processed pages represents the total number of validated results. The form evaluation unit 22 derives, for each validator, the throughput for the validation step, examples of which include the correct recognition rate (%), the processing time (in minute), and the processing speed (in page/minute), on the basis of the acquired processing information of the validation step. The form evaluation unit 22 determines, for each piece of read data, whether the validation result is correct.

In the example illustrated in FIG. 4, all of the reading step, the recognition step, and the validation step are evaluated using an evaluation form image. The term “evaluating” or “evaluation”, as used herein, is used to include deriving a value indicating the throughput for each step. Whether improvement is necessary for each of the steps is determined by comparing the value indicating the throughput for the step with a target value determined in advance for the step. For example, if the processing time of the reading step is less than the target value, it is determined that improvement is necessary. In this case, some action is taken, such as changing the image reading device 60. If the correct recognition rate in the recognition step is less than the target value or if the processing time of the recognition step is less than the target value, some action is taken, such as changing the recognition dictionary or the OCR software. If the correct recognition rate in the validation step is less than the target value or if the processing time of the validation step is less than the target value, some action is taken, such as increasing the number of validators or changing the validator. The action to be taken by the user on the basis of the evaluation result may be output together with the evaluation result.

For a step for which the throughput has been determined, no evaluation result may be output. Only for a step for which the throughput has not been determined, an evaluation result may be output.

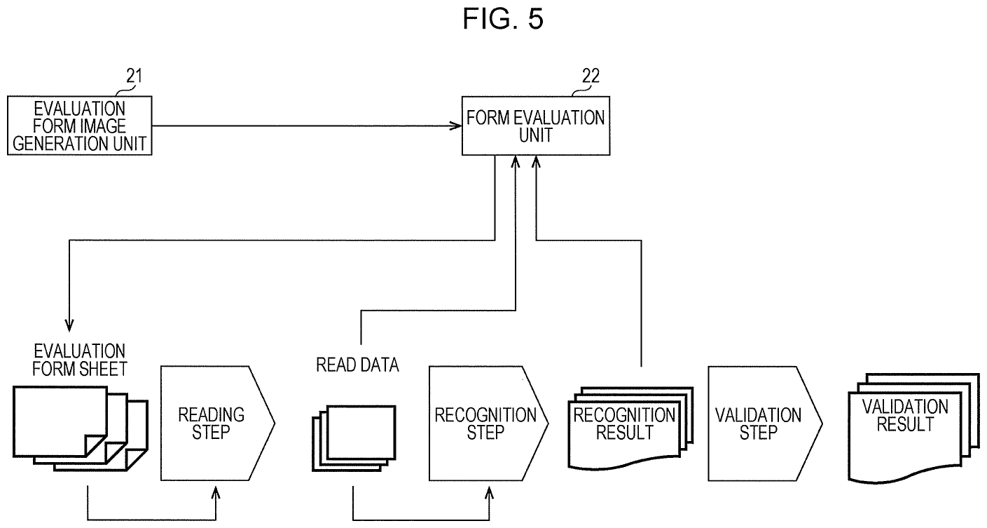

FIG. 5 illustrates a step evaluation process for some steps according to this exemplary embodiment.

As illustrated in FIG. 5, if the throughput for the validation step has been determined, only the throughputs for the reading step and the recognition step may be evaluated.

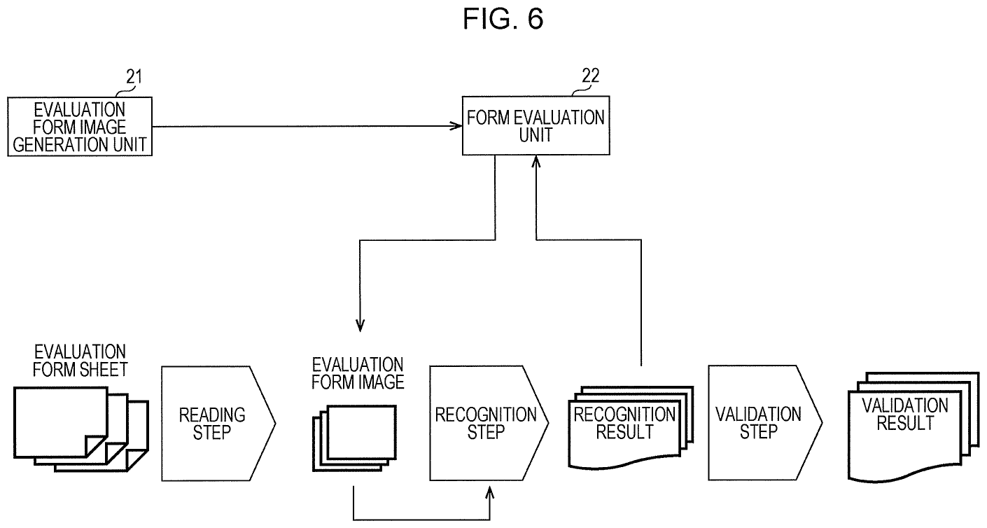

FIG. 6 illustrates another step evaluation process for some steps according to this exemplary embodiment.

As illustrated in FIG. 6, if the respective throughputs for the reading step and the validation step have been determined, only the throughput for the recognition step may be evaluated. In this case, in place of read data, evaluation form images are directly provided to the recognition step. At this time, noise, distortion, or the like may be added to the evaluation form images, as appropriate, so as to simulate actual read data.

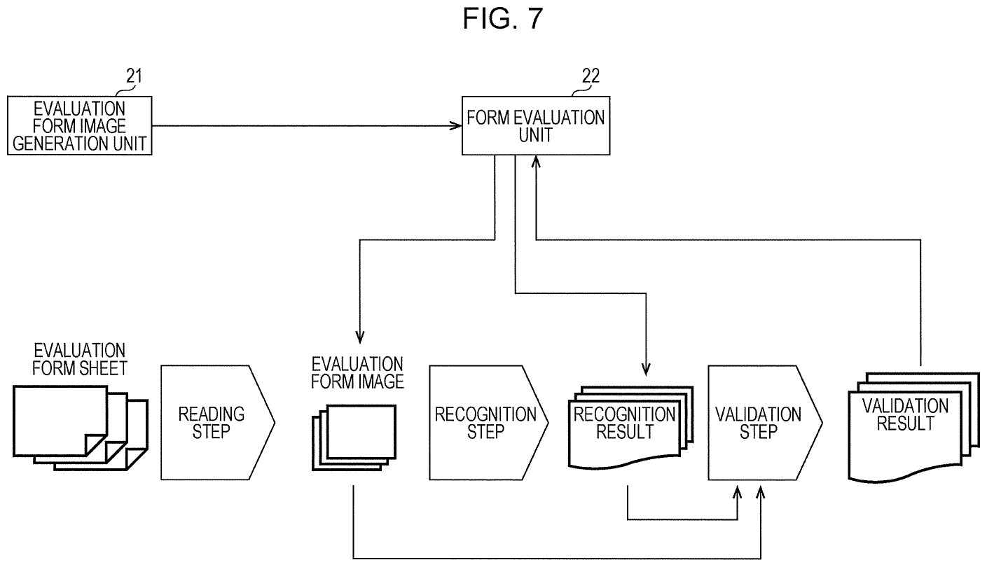

FIG. 7 illustrates still another step evaluation process for some steps according to this exemplary embodiment.

As illustrated in FIG. 7, if the respective throughputs for the reading step and the recognition step have been determined, only the throughput for the validation step may be evaluated. In this case, in place of read data, evaluation form images are directly provided to the validation step, and the recognition results of the evaluation form images are also provided to the validation step. At this time, the recognition results of the evaluation form images may contain errors to achieve any desired correct recognition rate so as to simulate the actual recognition results.

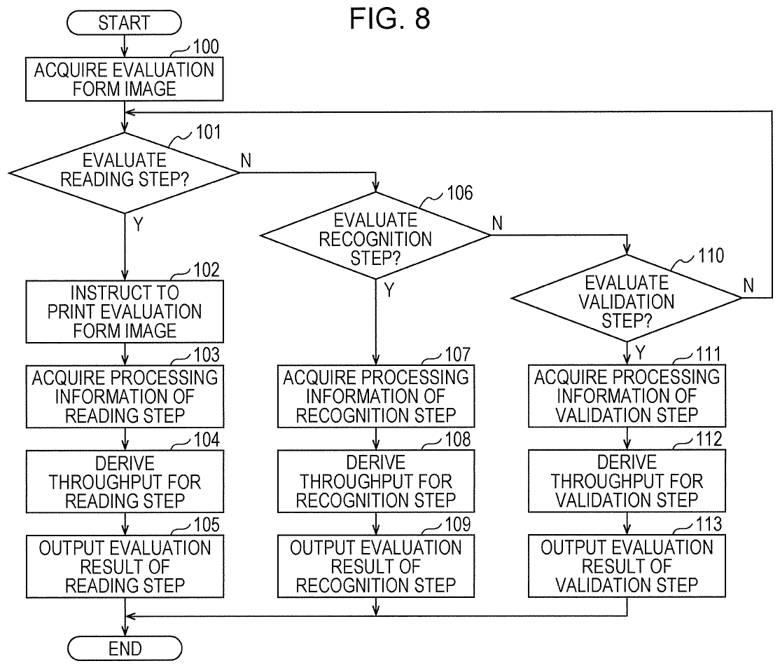

Next, the operation of the server apparatus 10 according to this exemplary embodiment will be described with reference to FIG. 8.

FIG. 8 is a flowchart illustrating an example process flow of the information processing program 12A according to this exemplary embodiment.

First, when the server apparatus 10 is instructed to execute a step evaluation process, the CPU 11A starts the information processing program 12A and executes the following operation steps.

In step 100 in FIG. 8, the CPU 11A acquires an evaluation form image. The evaluation form image may be an image acquired from the evaluation form image generation unit 21 or an image acquired from another server apparatus external to the form processing system 90.

In step 101, the CPU 11A determines whether to evaluate the reading step. If it is determined that the reading step is to be evaluated (if positive determination is obtained), the process proceeds to step 102. If it is determined that the reading step is not to be evaluated (if negative determination is obtained), the process proceeds to step 106.

In step 102, the CPU 11A provides an instruction to print the evaluation form image. An evaluation form sheet that is a printout of the evaluation form image is provided to the reading step. In the reading step, the evaluation form sheet is read using the image reading device 60 to obtain read data, and the read data is output.

In step 103, the CPU 11A acquires processing information of the reading step. The processing information of the reading step includes, as described above, the number of processed pages, the processing start time, and the processing end time, for example.

In step 104, the CPU 11A derives the throughput for the reading step, examples of which include the processing time (in minute) and the processing speed (in page/minute), on the basis of the processing information of the reading step acquired in step 103.

In step 105, the CPU 11A outputs an evaluation result of the reading step, including the value indicating the throughput derived in step 104, to the display unit 13, for example. Then, the series of processing operations performed in accordance with the information processing program 12A ends.

In step 106, the CPU 11A determines whether to evaluate the recognition step. If it is determined that the recognition step is to be evaluated (if positive determination is obtained), the process proceeds to step 107. If it is determined that the recognition step is not to be evaluated (if negative determination is obtained), the process proceeds to step 110.

In step 107, the CPU 11A acquires processing information of the recognition step. The processing information of the recognition step includes, as described above, the number of processed pages, the processing start time, the processing end time, the recognition dictionary, and the recognition result, for example.

In step 108, the CPU 11A derives, for each recognition dictionary, the throughput for the recognition step, examples of which include the correct recognition rate (%), the processing time (in minute), and the processing speed (in page/minute), on the basis of the processing information of the recognition step acquired in step 107.

In step 109, the CPU 11A outputs an evaluation result of the recognition step, including the value indicating the throughput derived in step 108, to the display unit 13, for example. Then, the series of processing operations performed in accordance with the information processing program 12A ends.

In step 110, the CPU 11A determines whether to evaluate the validation step. If it is determined that the validation step is to be evaluated (if positive determination is obtained), the process proceeds to step 111. If it is determined that the validation step is not to be evaluated (if negative determination is obtained), the process returns to step 101 and the CPU 11A waits.

In step 111, the CPU 11A acquires processing information of the validation step. The processing information of the validation step includes, as described above, the number of processed pages, the processing start time, the processing end time, the name of the validator, and the validation result, for example.

In step 112, the CPU 11A derives, for each validator, the throughput for the validation step, examples of which include the correct recognition rate (%), the processing time (in minute), and the processing speed (in page/minute), on the basis of the processing information of the validation step acquired in step 111.

In step 113, the CPU 11A outputs an evaluation result of the validation step, including the value indicating the throughput derived in step 112, to the display unit 13, for example. Then, the series of processing operations performed in accordance with the information processing program 12A ends.

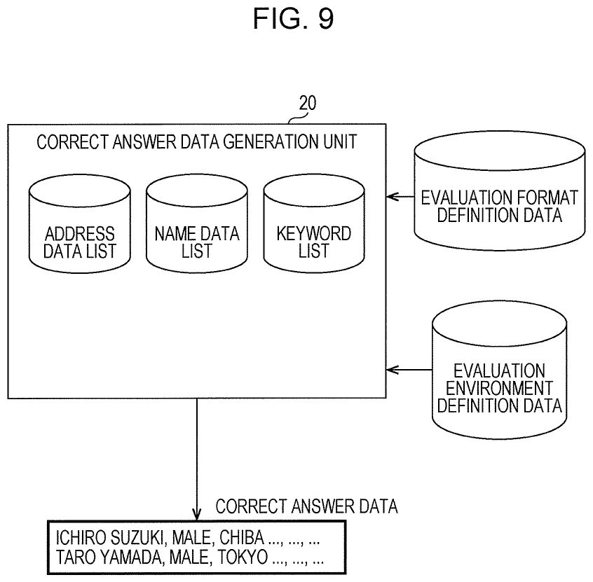

Next, the correct answer data generation process will be described in detail with reference to FIG. 9.

FIG. 9 illustrates a correct answer data generation process according to this exemplary embodiment.

As illustrated in FIG. 9, the correct answer data generation unit 20 is allowed to refer to an address data list, a name data list, and a keyword list. The address data list is a list of addresses and attributes (for example, district, prefecture, etc.) to be used as samples. The name data list is a list of names and attributes (for example, gender, age, etc.) to be used as samples. The keyword list is a list of keywords and attributes (for example, the name of a medical institution, the name of a government office, the name of a bank, the name of a company, etc.) to be used as samples. The address data list, the name data list, and the keyword list are stored in the storage unit 12.

Evaluation format definition data and the evaluation environment definition data (see FIG. 3) are stored in the storage unit 12. The evaluation format definition data is a portion of the form definition data described above. The evaluation format definition data defines the format of an evaluation form image. The format of an evaluation form image indicates, for example, a correspondence between frames and items in the evaluation form image such that a first frame is to be filled in with a name, a second frame is to be filled in with a gender, a third frame is to be filled in with an address, and so on. The evaluation environment definition data is data that, as described above, defines an operational environment related to the form processing in advance.

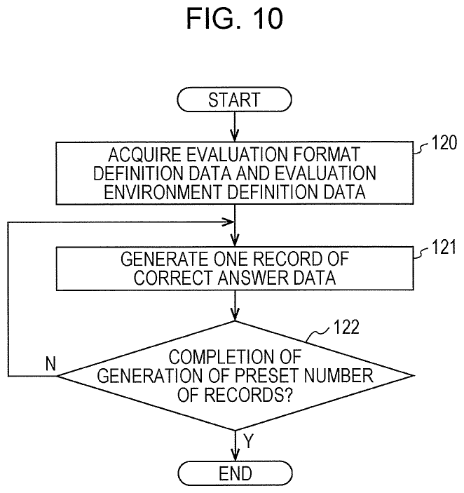

FIG. 10 is a flowchart illustrating an example flow of the correct answer data generation process according to this exemplary embodiment.

First, when the server apparatus 10 is instructed to execute a correct answer data generation process, the CPU 11A starts the information processing program 12A and executes the following operation steps.

In step 120 in FIG. 10, the CPU 11A serves as the correct answer data generation unit 20 and acquires evaluation format definition data and evaluation environment definition data.

In step 121, the CPU 11A serves as the correct answer data generation unit 20 and generates one record of correct answer data in accordance with the evaluation format definition data and the evaluation environment definition data that are acquired in step 120. Specifically, the CPU 11A extracts an address that matches the evaluation environment definition data from the address data list. The CPU 11A also extracts a name that matches the evaluation environment definition data from the name data list. The CPU 11A further extracts a keyword that matches the evaluation environment definition data from the keyword list. The extracted address, name, and keyword are used to generate one record of correct answer data. Examples of the record of correct answer data include “Ichiro Suzuki, male, Chiba . . . ”. For example, when the evaluation environment definition data indicates that “the person who fills in the target data is a student of XYZ Junior High School in Fukuoka Prefecture”, the CPU 11A extracts an address related to Fukuoka Prefecture from the address data list, and further extracts a name common in Fukuoka Prefecture from the name data list.

In step 122, the CPU 11A serves as the correct answer data generation unit 20 and determines whether the generation of a number of records of correct answer data, the number of which is preset in the evaluation environment definition data, is completed. If it is determined that the generation of the preset number of records of correct answer data is not completed (if negative determination is obtained), the process returns to step 121, and the CPU 11A repeatedly performs the process. If it is determined that the generation of the preset number of records of correct answer data is completed (if positive determination is obtained), the correct answer data generation process according to the information processing program 12A ends.

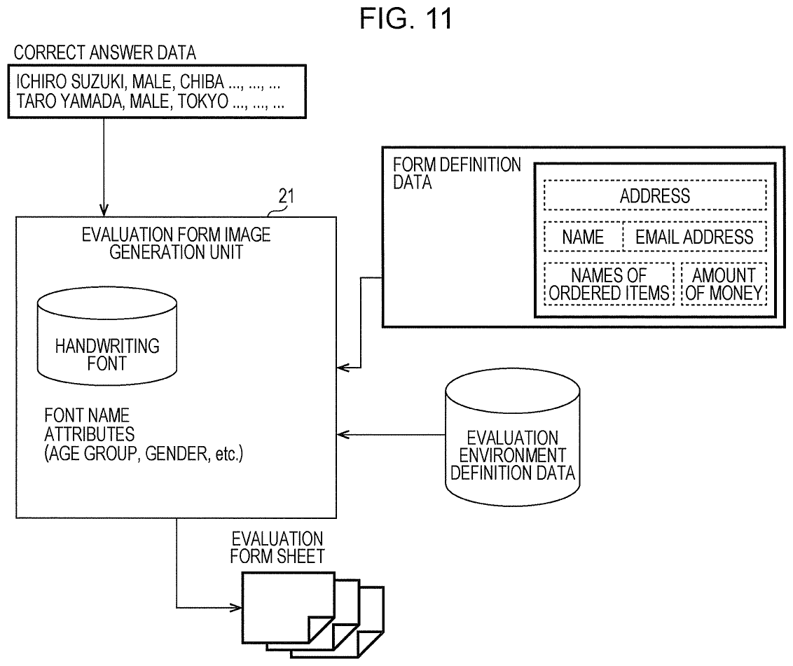

Next, the evaluation form image generation process will be described in detail with reference to FIG. 11.

FIG. 11 illustrates an evaluation form image generation process according to this exemplary embodiment.

As illustrated in FIG. 11, the evaluation form image generation unit 21 is allowed to refer to a handwriting font database. The handwriting font database stores a plurality of types of handwriting fonts such that each of the plurality of types of handwriting fonts is associated with a font name and attributes (for example, an age group, a gender, etc.). The handwriting font database is stored in the storage unit 12.

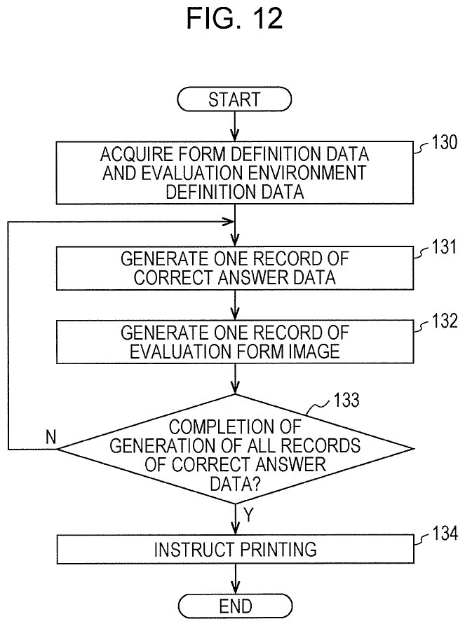

FIG. 12 is a flowchart illustrating an example flow of the evaluation form image generation process according to this exemplary embodiment.

First, when the server apparatus 10 is instructed to execute an evaluation form image generation process, the CPU 11A starts the information processing program 12A and executes the following operation steps.

In step 130 in FIG. 12, the CPU 11A serves as the evaluation form image generation unit 21 and acquires form definition data and evaluation environment definition data.

In step 131, the CPU 11A serves as the evaluation form image generation unit 21 and acquires one record of correct answer data.

In step 132, the CPU 11A serves as the evaluation form image generation unit 21 and generates one record of an evaluation form image in accordance with the form definition data, the evaluation environment definition data, and the correct answer data. Specifically, the CPU 11A selects a handwriting font that matches the evaluation environment definition data from the handwriting font database and converts a character string of the correct answer data into that in the selected handwriting font. Then, the CPU 11A arranges the character string in the handwriting font, which is obtained as a result of conversion, in the corresponding item in a blank form in accordance with layout information defined in the form definition data. Accordingly, one record of an evaluation form image is generated. For example, when the evaluation environment definition data indicates that “the person who fills in the target data is a student of XYZ Junior High School in Fukuoka Prefecture”, the CPU 11A selects a handwriting font corresponding to the age group of junior high school students.

In step 133, the CPU 11A serves as the evaluation form image generation unit 21 and determines whether the generation of evaluation form images of all the number of records of correct answer data is completed. If it is determined that the generation of evaluation form images of all the number of records of correct answer data is not completed (if negative determination is obtained), the process returns to step 131, and the CPU 11A repeatedly performs the process. If it is determined that the generation of evaluation form images of all the number of records of correct answer data is completed (if positive determination is obtained), the process proceeds to step 134.

In step 134, the CPU 11A serves as the evaluation form image generation unit 21 and instructs the printer (not illustrated) to print the evaluation form images generated in the way described above. Then, the evaluation form image generation process according to the information processing program 12A ends.

In the foregoing description, a printout of an evaluation form image, or an evaluation form sheet, is used to evaluate the reading step.

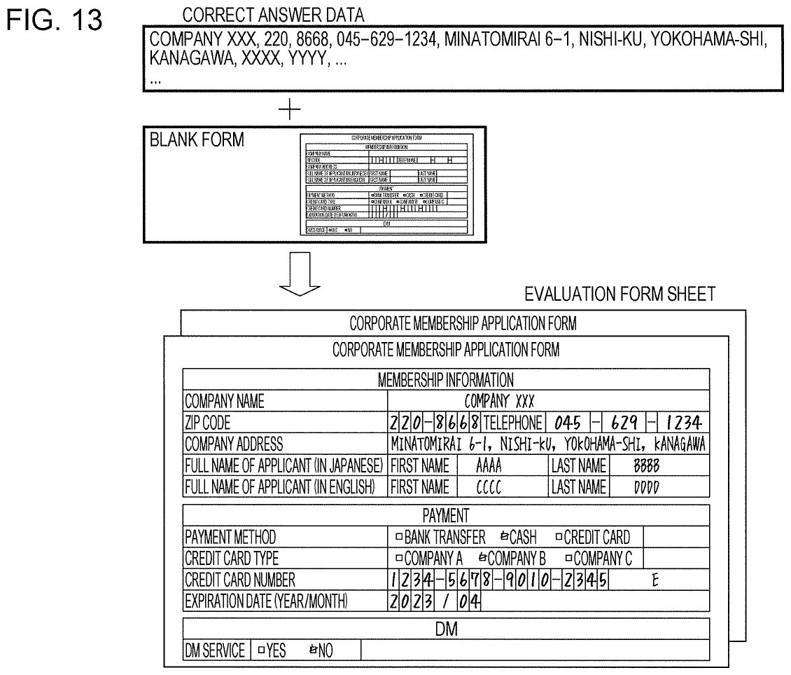

FIG. 13 illustrates an example of correct answer data, a blank form, and evaluation form sheets according to this exemplary embodiment.

Character strings of the correct answer data illustrated in FIG. 13 are converted into those in a handwriting font that matches the evaluation environment definition data described above. The character strings in the handwriting font, which are obtained as a result of conversion, are arranged in the respective items in a blank form in accordance with layout information defined in the form definition data described above to obtain an evaluation form image. The evaluation form image is printed to generate an evaluation form sheet.

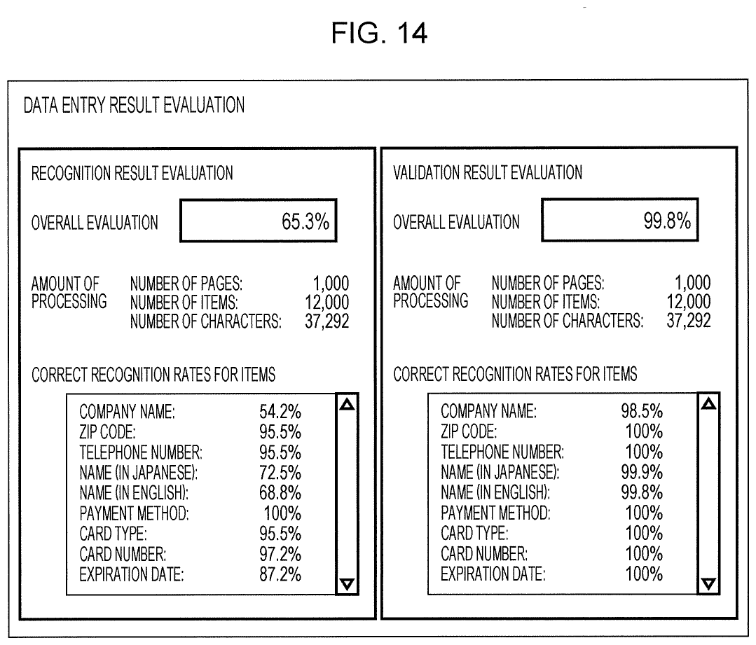

Next, example screens for the step evaluation process according to this exemplary embodiment will be described in detail with reference to FIGS. 14 to 17.

FIG. 14 is a front view of an example of a data entry result evaluation screen according to this exemplary embodiment.

The data entry result evaluation screen illustrated in FIG. 14 is a screen that displays evaluation results for steps of the form processing. The data entry result evaluation screen is displayed on the display unit 13, for example. The data entry result evaluation screen illustrated in FIG. 14 includes, for example, a recognition result evaluation screen and a validation result evaluation screen. Each of the recognition result evaluation screen and the validation result evaluation screen includes, for example, an overall evaluation, an amount of processing, and correct recognition rates for items in forms. The overall evaluation represents the average of the correct recognition rates for the items in the forms. The amount of processing represents the number of pages of evaluation form images, the number of items in the forms, and the number of characters. The correct recognition rates for the items in the forms represent the respective correct recognition rates for items such as company name, zip code, and telephone number. As illustrated in FIG. 14, the evaluation result of the recognition step may include the correct recognition rate of the recognition result (overall evaluation) of the recognition step and the correct recognition rates of the respective recognition results for the items in the forms. The evaluation result of the recognition step may include the processing time of the recognition step. The evaluation result of the validation step may include the correct recognition rate of the validation result (overall evaluation) of the validation step and the correct recognition rates of the respective validation results for the items in the forms. The evaluation result of the validation step may include the processing time of the validation step.

The evaluation results illustrated in FIG. 14 indicate that it is difficult to obtain a sufficient correct recognition rate only in the recognition step and that the validation step is necessary. It is also indicated that the correct recognition rate for the item “company name” is low in the recognition step and that the load on the validation step is high. To address this inconvenience, it may be possible to improve the performance of the OCR software to be used in the recognition step to reduce the load on the validation step. In the validation step, in contrast, sufficient correct recognition rates are obtained. It is thus determined that the form processing can be started unless any other problem occurs in the processing time or the like. Such a determination about the evaluation results may also be displayed together with the evaluation results.

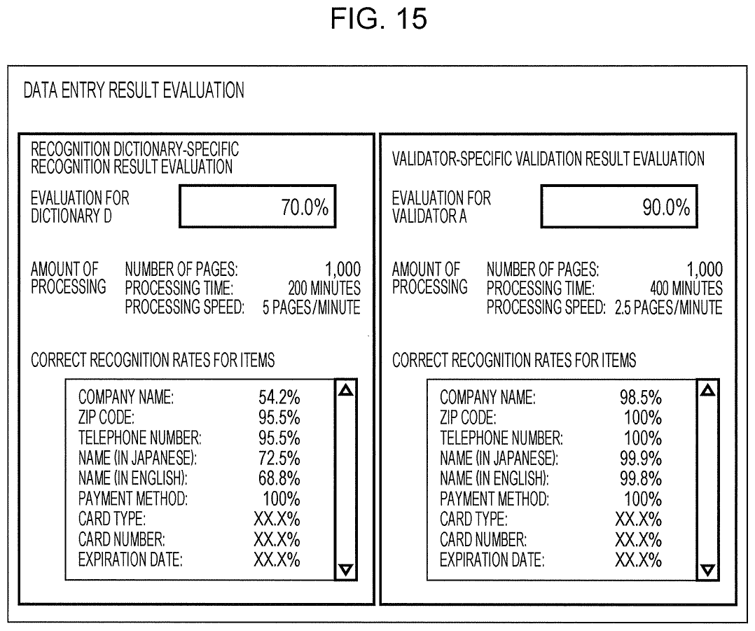

FIG. 15 is a front view of another example of the data entry result evaluation screen according to this exemplary embodiment.

The data entry result evaluation screen illustrated in FIG. 15 is a screen that displays evaluation results for steps of the form processing. The data entry result evaluation screen is displayed on the display unit 13, for example. The data entry result evaluation screen illustrated in FIG. 15 includes, for example, a recognition-dictionary-specific recognition result evaluation screen and a validator-specific validation result evaluation screen. The recognition-dictionary-specific recognition result evaluation screen includes, for example, an evaluation for dictionary D, an amount of processing, and correct recognition rates for items in forms. The evaluation for the dictionary D represents the average of the correct recognition rates for the items in the forms when the dictionary D is used. The amount of processing represents the number of pages of evaluation form images, the processing time taken for the recognition step, and the processing speed. The correct recognition rates for the items in the forms represents the respective correct recognition rates for the items when the dictionary D is used. The validator-specific validation result evaluation screen includes, for example, an evaluation for validator A, an amount of processing, and correct recognition rates for the items in the forms. The evaluation for the validator A represents the average of the correct recognition rates for the items in the forms when the validator A performs a validation operation. The amount of processing represents the number of pages of evaluation form images, the processing time taken for the validation step, and the processing speed. The correct recognition rates for the items in the forms represents the respective correct recognition rates for the items in the forms when the validator A performs a validation operation.

The evaluation results illustrated in FIG. 15 indicate an evaluation result specific to each recognition dictionary about the recognition step. If the correct recognition rate for the dictionary D is low, some action is considered to be taken, such as using a different dictionary with a relatively high correct recognition rate. In addition, the evaluation result of the validation step by validator is determined. If the correct recognition rate for the validator A is low, some action is considered to be taken, such as changing the validator A to any other validator with a relatively high correct recognition rate. In the foregoing description, the determination is based on the correct recognition rate. Alternatively, the determination may be based on the processing time (or processing speed), or may be based on the correct recognition rate and the processing time (or processing speed). Such countermeasures based on the evaluation results may be displayed together with the evaluation results.

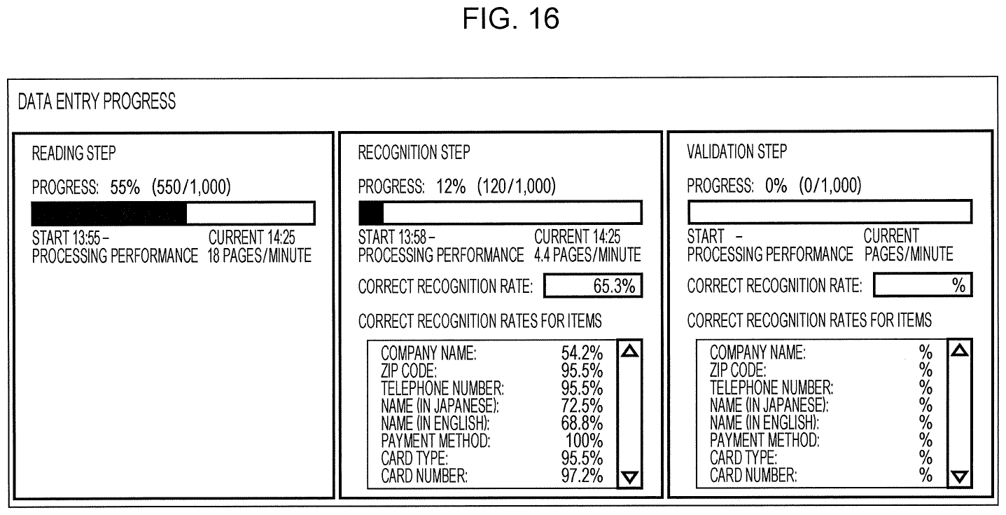

FIG. 16 is a front view of an example of a data entry progress screen according to this exemplary embodiment.

The data entry progress screen illustrated in FIG. 16 is a screen that displays progress for steps of the form processing. The data entry progress screen is displayed on the display unit 13, for example. The data entry progress screen illustrated in FIG. 16 includes, for example, respective progress screens for the reading step, the recognition step, and the validation step. The progress screen for the reading step presents, for example, the progress percentage, the start time, the current time, and the processing performance. The processing performance is expressed as the processing speed (in page/minute). The progress screen for the recognition step presents, for example, the progress percentage, the start time, the current time, the processing performance, the correct recognition rate, and the respective correct recognition rates for the items. The correct recognition rate is expressed as the average of the respective correct recognition rates for the items. The progress screen for the validation step presents, like the recognition step, the progress percentage, the start time, the current time, the processing performance, the correct recognition rate, and the respective correct recognition rates for the items, although the validation step has not been started in the illustrated example.

As illustrated in FIG. 16, the reference to progress for each step enables the evaluation of the step even if the step is not completed.

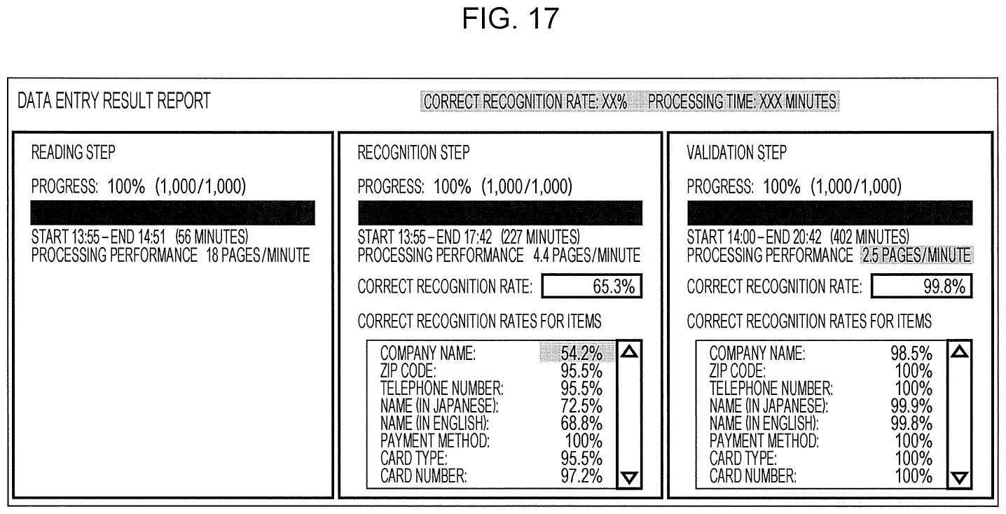

FIG. 17 is a front view of an example of a data entry result report screen according to this exemplary embodiment.

The data entry result report screen illustrated in FIG. 17 is a screen that displays the completion of the steps of the form processing. The data entry result report screen is displayed on the display unit 13, for example. The data entry result report screen illustrated in FIG. 17 is obtained when each of the steps in the data entry progress screen illustrated in FIG. 16 is completed.

The result report illustrated in FIG. 17 indicates that the correct recognition rate for the item “company name” is low in the recognition step and that it can take time to validate this item in the validation step. Accordingly, it is considered that the OCR software to be used in the recognition step is changed or the settings of the OCR software are changed and then evaluation is performed again. Since the validation step takes time, action is considered to be taken, such as increasing the number of validators.

In this exemplary embodiment, accordingly, before the start of operation of the form processing system 90, an evaluation result for at least one step of form processing is output. Thus, a necessary action may be taken against any potentially problematic step before the operation is started.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

In the foregoing description, a server apparatus is exemplified as an example of an information processing apparatus according to an exemplary embodiment. Exemplary embodiments may be implemented using a program for causing a computer to execute the functions of the components of the server apparatus. Exemplary embodiments may be implemented using a computer-readable non-transitory storage medium storing the program described above.

In addition, the configuration of the server apparatus provided in the exemplary embodiment described above is an example, and may be modified depending on the situation without departing from the spirit of the present disclosure.

In addition, the flow of the processes of the program provided in the exemplary embodiment described above is also an example. An unnecessary step may be deleted, a new step may be added, or the processing order may be changed without departing from the spirit of the present disclosure.

In the exemplary embodiment described above, furthermore, a program is executed to implement the processes according to the exemplary embodiment by a software configuration using a computer, by way of example without limitation. The exemplary embodiment may be implemented by a hardware configuration or a combination of a hardware configuration and a software configuration, for example.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to:
acquire an evaluation form image in which an item and correct answer data indicating a correct answer of a recognition result for the item are associated with each other in advance; and
output, when the acquired evaluation form image is processed in at least one step of form processing, an evaluation result of the at least one step of the form processing.

2. The information processing apparatus according to claim 1,
wherein the form processing includes a plurality of steps, and
wherein the processor is configured to output, for each of the plurality of steps, an evaluation result of evaluating the step using a different evaluation item.

3. The information processing apparatus according to claim 2,
wherein the plurality of steps include a validation step of obtaining a validation result that is a result of performing a validation operation on a recognition result obtained as a result of recognizing the evaluation form image, and
wherein the processor is configured to further output, for the validation step, an evaluation result including at least one of a processing time or a correct recognition rate of a validation result for each validator.

4. The information processing apparatus according to claim 2,
wherein the plurality of steps include a recognition step of obtaining a recognition result that is a result of recognizing the evaluation form image, and
wherein the processor is configured to further output, for the recognition step, an evaluation result including at least one of a processing time or a correct recognition rate of a recognition result for each recognition dictionary.

5. The information processing apparatus according to claim 2,
wherein the plurality of steps include a reading step of reading a printout of the evaluation form image to obtain a reading result, and
wherein the processor is configured to further output an evaluation result including a processing time of the reading step.

6. The information processing apparatus according to claim 1, wherein the evaluation form image comprises an image in which one or more characters in a handwriting font obtained by converting the correct answer data are arranged in a corresponding item in a blank form.

7. The information processing apparatus according to claim 2, wherein the evaluation form image comprises an image in which one or more characters in a handwriting font obtained by converting the correct answer data are arranged in a corresponding item in a blank form.

8. The information processing apparatus according to claim 3, wherein the evaluation form image comprises an image in which one or more characters in a handwriting font obtained by converting the correct answer data are arranged in a corresponding item in a blank form.

9. The information processing apparatus according to claim 4, wherein the evaluation form image comprises an image in which one or more characters in a handwriting font obtained by converting the correct answer data are arranged in a corresponding item in a blank form.

10. The information processing apparatus according to claim 5, wherein the evaluation form image comprises an image in which one or more characters in a handwriting font obtained by converting the correct answer data are arranged in a corresponding item in a blank form.

11. The information processing apparatus according to claim 1, wherein the correct answer data comprises data generated in accordance with evaluation environment definition data that defines in advance an operational environment related to the form processing.

12. The information processing apparatus according to claim 6, wherein the handwriting font comprises a font converted from the correct answer data in accordance with evaluation environment definition data that defines in advance an operational environment related to the form processing.

13. The information processing apparatus according to claim 7, wherein the handwriting font comprises a font converted from the correct answer data in accordance with evaluation environment definition data that defines in advance an operational environment related to the form processing.

14. The information processing apparatus according to claim 8, wherein the handwriting font comprises a font converted from the correct answer data in accordance with evaluation environment definition data that defines in advance an operational environment related to the form processing.

15. The information processing apparatus according to claim 9, wherein the handwriting font comprises a font converted from the correct answer data in accordance with evaluation environment definition data that defines in advance an operational environment related to the form processing.

16. The information processing apparatus according to claim 10, wherein the handwriting font comprises a font converted from the correct answer data in accordance with evaluation environment definition data that defines in advance an operational environment related to the form processing.

17. The information processing apparatus according to claim 11, wherein the operational environment includes at least one of a geographical location of a region associated with a form, a name of a company associated with the form, an age group of a person who fills in the form, or a gender of the person who fills in the form.

18. The information processing apparatus according to claim 12, wherein the operational environment includes at least one of a geographical location of a region associated with a form, a name of a company associated with the form, an age group of a person who fills in the form, or a gender of the person who fills in the form.

19. The information processing apparatus according to claim 13, wherein the operational environment includes at least one of a geographical location of a region associated with a form, a name of a company associated with the form, an age group of a person who fills in the form, or a gender of the person who fills in the form.

20. A non-transitory computer readable medium storing a program causing a computer to execute a process for information processing, the process comprising:
acquiring an evaluation form image in which an item and correct answer data indicating a correct answer of a recognition result for the item are associated with each other in advance; and
outputting, when the acquired evaluation form image is processed in at least one step of form processing, an evaluation result of the at least one step of the form processing.
